(19) United States
(12) Patent Application Publication
(10) Pub. No.: US 2008/0298754 A1
(43) Pub. Date: Dec. 4, 2008

(54) Optical Cable and Method for Producing an Optical Cable

(75) Inventors: Gunter Wunsch, Neustadt bei Coburg (DE); Rainer Kamps, Grub am Forst (DE)

Correspondence Address: Corining Cable Systems;Intellectual Propery Department, 800 17th Street NW, Pobox 489, Hickory, NC, 28603, US

(73) Assignee: CCS TECHNLOGY, INC., WILMINGTON DELAWARE, DE (US)

(21) Appl. No.: 11/659,256

(22) PCT Filed: Jul. 28, 2005
(86) PCT No.: PCT/DE05/01336

§ 371 Date: Feb. 2, 2007

(30) Foreign Application Priority Data
Aug. 3, 2004 (DE) 102004037589.5

(51) Int. Cl. G02B 6/44; C03C 25/10

(52) U.S. Cl. 385/103; 65/430

(57) ABSTRACT

An optical cable (1) comprises a cable sheath (11) and at least two optical transmission elements (101) and (102), which are arranged within the cable sheath (11). One (101) of the optical transmission elements (101) and (102) comprises a buffer tube (1011), at least one optical waveguide (10101) and at least one swelling element (10111). The buffer tube (1011) surrounds the at least one optical waveguide (10101) and the at least one swelling element (10111). The swelling element (10111) comprises a swelling material, which can swell by supplying it with water. If water penetrates into the optical transmission element, the swelling element (10111) swells and seals off the optical transmission element, so that spreading of the water in the longitudinal direction of the optical transmission element is prevented.

### FIELD OF INVENTION

The invention relates to an optical cable with optical transmission elements, which have a buffer tube with low elongation at break. The invention also relates to a method for producing an optical cable with which a good longitudinal water tightness of optical transmission elements can be achieved.

### BACKGROUND OF THE INVENTION

An optical cable, which may be intended for the construction of a broadband communications network, contains a large number of optical waveguides. In general, the optical cable contains a number of optical transmission elements, which are also referred to as buffered fibers or “units”. Each of the optical transmission elements contains a number of optical waveguides.

For example, the optical cable may contain 12 optical transmission elements and each of the optical transmission elements may contain 12 optical waveguides.

Furthermore, the optical cable comprises a cable sheath and a cable core. The cable sheath surrounds the cable core. The optical transmission elements are arranged within the cable core. The cable sheath is intended for protecting the cable core and comprises materials such as for example polyethylene (PE), polypropylene (PP) or polyamide (PA).

In a portion of the optical cable of a specific length there run portions of the optical transmission elements of a slightly greater length. The excess length of the optical transmission elements in the portion of the optical cable has the effect of avoiding exposure of the optical transmission elements to excessive tensile stresses when the optical cable is bent or stretched.

For example, in a portion of an optical cable of round cross section, the optical transmission elements may be arranged in the form of a helix around the longitudinal axis of the portion. In this case, a central fiber running along the longitudinal axis of the portion may also be provided to stabilize the arrangement of optical transmission elements.

The cable core of the optical cable generally comprises a core filling compound. The core filling compound is surrounded by the cable sheath. The optical transmission elements are embedded in the core filling compound.

An optical transmission element of the optical cable comprises a buffer tube. The optical waveguides of the optical transmission elements are surrounded by the buffer tube. The buffer tube of the optical transmission elements usually contains a matrix polymer in which a filler is embedded. The matrix polymer is, for example, ethyl vinyl acetate or polyvinyl chloride. The filler is, for example, chalk. A high percentage by mass of the filler reduces the elongation at break and tensile strength of the buffer tube. This allows the buffer tube of an optical transmission element to be detached without special tools.

In a portion of the optical transmission element of a specific length there usually run portions of the optical waveguides of a slightly greater length. This excess length of the optical waveguides in the portion of the optical transmission element has the effect of avoiding the occurrence of excessive tensile stresses in the optical waveguides when the optical transmission element is bent or stretched.

For example, in a portion of an optical transmission element of round cross section, the optical waveguides may be respectively arranged in the form of a helix around the longitudinal axis of the portion. In this case, a central fiber running along the longitudinal axis of the portion and stabilizing the arrangement of optical waveguides may also be provided.

Furthermore, the optical transmission element contains a buffered-fiber filling compound. The buffered-fiber filling compound is surrounded by the buffer tube. The optical waveguides of the optical transmission element are embedded in the buffered-fiber filling compound.

The buffered-fiber filling compound is intended to restrict as little as possible the mobility of the optical waveguides within the buffer tube of the optical transmission element, in order that the optical waveguides can use their excess lengths to allow them to be displaced with respect to one another and with respect to the buffer tube when the optical cable is bent. In this way, no excess tensile stresses occur in the optical waveguides. In order that the interspace between the buffer tube and the optical waveguides is completely filled, and consequently closed off in a watertight manner, a substance with a viscosity that is not too high, for example a thixotropic gel, is usually used as the buffered-fiber filling compound.

However, an interaction may occur between components of the buffered-fiber filling compound and the matrix polymer of the buffer tube, with the consequence that the sheath absorbs compound by migration. The migration causes the mechanical properties of the buffered-fiber filling compound and of the buffer tube to change.

The use of a buffered-fiber filling compound which comprises a high-viscosity gel allows this migration to be reduced. However, a high-viscosity gel can only deform very slowly. This has the effect, for example, that penetration of the buffered-fiber filling compound into small interspaces between the optical waveguides is considerably delayed, which in the production of the optical cable greatly reduces the rate at which a number of optical waveguides can be processed to form an optical transmission element.

### SUMMARY OF THE INVENTION

Accordingly, the object of the invention is to specify an optical cable with optical transmission elements of which the buffer tube has a low elongation at break, of which the optical waveguides have great mobility within the buffered fiber and in which spreading of water in the longitudinal direction within the buffered fiber is precluded.

The optical cable according to the invention comprises a cable sheath and a cable core, which is surrounded by the cable sheath. The cable core has a centrally arranged swelling filament and at least two optical transmission elements. The at least two optical transmission elements are arranged around the centrally arranged swelling filament. At least one of the optical transmission elements comprises a buffer tube, at least one optical waveguide and at least one swelling element. The swelling element comprises a swelling material, which can swell by supplying it with water, in order to seal off the optical transmission element in the longitudinal direction. Furthermore, the buffer tube surrounds the at least one optical waveguide and the at least one swelling element.

In an optical cable according to the invention, at least one optical transmission element therefore comprises a dry swelling element.

The optical transmission element preferably has an interspace which is free from gel.

Instead of a gel-like buffered-fiber filling compound of a constant volume, a swelling element with dry swelling material, the volume of which increases greatly on contact with water, is provided.

In particular, the optical transmission element has within the buffer tube an interspace which is adjacent the at least one optical waveguide and the at least one swelling element and can be sealed in a watertight manner by swelling of the swelling material.

The interspace between the buffer tube and the optical waveguides makes it possible for the optical waveguides to be highly mobile. When the optical cable is bent, the optical waveguides can use their excess length to allow them to be easily displaced everywhere with respect to one another and with respect to the buffer tube.

The at least one swelling element of the optical transmission element is preferably formed as a fiber. The fiber is arranged within the buffer tube and alongside the at least one optical waveguide.

For example, a number of swellable fibers may be evenly distributed between a number of optical waveguides within the buffer tube. In this way, there is a swelling element in the vicinity of each interspace within the buffer tube. This allows even materials with lower swellability to be used as filling elements.

The at least one swelling element of the optical transmission element is preferably arranged as a layer on an inner surface of the buffer tube.

In this case, the swelling element surrounds the optical waveguides of the optical transmission element. Water penetrating due to a break in the buffer tube therefore first encounters the swelling material, so that the optical transmission element is sealed in the area around the break before the water can reach the optical waveguides and adversely influence their optical properties.

The at least one swelling element of the optical transmission element is preferably arranged on an outer surface of the at least one optical waveguide.

In this case, the swelling element surrounds each of the optical waveguides of the optical transmission element. It is consequently ensured that there is swelling material in the vicinity of each interspace within the buffer tube. This allows even swelling materials of lower swellability to be used. It is also ensured that penetrating water reaches the swelling material that is arranged around the optical waveguide before it can adversely influence the optical properties of the optical waveguide.

The at least one swelling element of the optical transmission element is preferably extruded from a melt of a swellable polymer. In particular, the melting or softening point of the polymer is as low as possible, but above the melting or softening point of the buffer tube of the optical transmission element.

The at least one swelling element of the optical transmission element preferably comprises a matrix polymer and a swellable filler embedded in the matrix polymer.

The swelling element may in this case be extruded from a melt of a mixture of the matrix polymer and the filler.

The optical transmission element preferably comprises a yarn with a swelling material. The yarn runs within the buffer tube and alongside the at least one optical waveguide.

For example, in a portion of an optical transmission element of round cross section, the yarn may run centrally along the longitudinal axis of the portion. In this case, the optical waveguides may respectively be arranged in the form of a helix around the yarn.

The swelling element of the optical transmission element is preferably arranged as a layer on an outer surface of the at least one yarn.

The layer may comprise a matrix polymer and a filler, which is embedded in the matrix polymer.

In particular, the yarn may comprise polyester.

The optical transmission element preferably has between the buffer tube and the optical waveguides an interspace in which a powder which comprises the at least one swelling element is arranged.

In particular, the swellable powder may comprise a further filler, such as for example talc.

The buffer tube of the optical transmission element preferably comprises a base polymer with a high plasticizer content and a filler, which is embedded in the base polymer. The percentage by mass of the filler within the overall mass of the base polymer and the filler is chosen such that the elongation at break of the buffer tube is significantly reduced and is preferably between 20% and 90%. In particular, the percentage by mass is 70%.

The base polymer with a high plasticizer content preferably comprises one of the materials ethyl vinyl acetate (EVA) and polyvinyl chloride (PVC) and the filler comprises a swelling powder.

The at least one optical waveguide preferably comprises a layer which is arranged on the outer surface of the optical waveguide and comprises an acrylate.

The swelling material preferably comprises a polyacrylic acid or a salt of a polyacrylic acid, such as for example sodium polyacrylate.

The object of the invention is also to specify a method for producing an optical cable of which the optical transmission elements have a buffer tube with low elongation at break and prevent spreading of water in the longitudinal direction.

The method according to the invention for producing an optical cable comprises a step of creating at least two optical transmission elements. Of the at least two optical transmission elements, at least one is created by a step of supplying at least one optical waveguide, a subsequent step of creating at least one swelling element and a subsequent step of extruding a buffer tube around the at least one optical waveguide and around the at least one swelling element.

Subsequently, the at least two optical transmission elements are arranged around a centrally arranged swelling filament.

In the production of an optical cable as provided by the invention, therefore, no gel-like buffered-fiber filling compound in which the optical waveguides could be embedded is supplied. Instead, dry swelling elements are used.

The step of creating the at least one swelling element preferably comprises a step of preparing a melt of a swellable polymer and a subsequent step of extruding the at least one swelling element as a fiber from the swellable polymer.

For example, a number of optical waveguides and a number of swelling fibers may be created and stranded with one another.

The step of creating the at least one swelling element preferably comprises a step of preparing a melt of a swellable polymer and a step of extruding the at least one swelling element as a swellable sheath around the at least one optical waveguide.

For example, the swellable sheath may be created as a common sheath around all the optical waveguides running into an extruder. In this case, the swellable sheath may be coextruded with the buffer tube.

The swellable sheath may, however, also be created in a first step as a sheath around an individual one of the optical waveguides in each case, before in a second step the buffer tube is created around all the optical waveguides. In this case, both the respective swellable sheath and the buffer tube may be extruded.

The step of creating the at least one swelling element preferably comprises a step of preparing a mixture of a swellable filler and a matrix polymer and a step of creating a swellable sheath around the at least one optical waveguide from the mixture of the swellable filler and the matrix polymer.

In this case, a matrix polymer that is not in fact swellable is premixed with a swellable filler. The swellable sheath is subsequently created from the mixture of the filler and the matrix polymer.

The step of creating the at least one swelling element preferably comprises a step of preparing at least one yarn, a subsequent step of creating a swelling material by premixing a matrix polymer and a filler and a subsequent step of coating the at least one yarn with the swelling material.

For example, a number of yarns may be coated with swellable material and subsequently stranded with the optical waveguides.

The step of creating the at least one swelling element preferably comprises a step of supplying a powder with swelling material.

For example, the powder may be sprinkled in during the stranding of the optical waveguides.

The step of creating the at least one swelling element preferably comprises a step of supplying a swelling powder and a step of supplying a further filler, such as for example a step of supplying talc.

The swelling element may preferably comprise a swelling material and a polyacrylate acid or a salt of a polyacrylic acid, such as for example sodium polyacrylate.

### BRIEF DESCRIPTION OF THE FIGURES

The invention is explained below on the basis of the exemplary embodiments represented in the drawings.

FIG. 1 shows an optical cable according to a preferred exemplary embodiment of the present invention.

FIG. 2A shows the optical transmission element of the optical cable according to a first exemplary embodiment of the present invention.

FIG. 2B shows the optical transmission element of the optical cable according to a second exemplary embodiment of the present invention.

FIG. 2C shows the optical transmission element of the optical cable according to a third exemplary embodiment of the present invention.

FIG. 2D shows the optical transmission element of the optical cable according to a fourth exemplary embodiment of the present invention.

FIG. 2E shows the optical transmission element of the optical cable according to a fifth exemplary embodiment of the present invention.

### DETAILED DESCRIPTION OF THE INVENTION

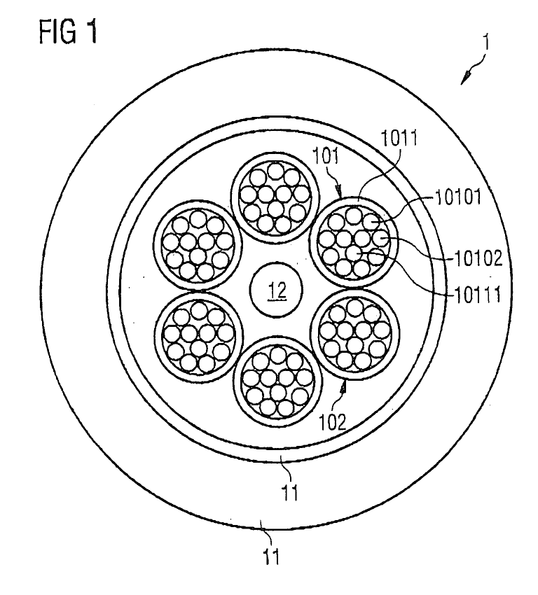

In FIG. 1, an optical cable according to a first exemplary embodiment of the present invention is represented. The optical cable 1 comprises the cable sheath 11, which surrounds the interior of the cable, referred to as the cable core. The cable sheath 11 comprises materials such as polyethylene (PE), polypropylene (PP) or polyamide (PA). Furthermore, the optical cable 1 contains the optical transmission elements 101 and 102, which are arranged within the cable sheath 11. The optical transmission element 101 comprises the buffer tube 1011. The buffer tube 1011 contains a matrix polymer such as polyvinyl chloride or ethyl vinyl acetate, in which a passive filler such as chalk is embedded. The elongation at break or tensile strength of the buffer tube 1011 can be set by means of the percentage by mass of the filler. The elongation at break is preferably set low, in order that the buffer tube 1011 can be removed without special tools. The optical transmission element 101 also comprises the optical waveguides 10101 and 10102 and the swelling element 10111. The optical waveguides 10101 and 10102 and the swelling element 10111 are arranged within the buffer tube 1011. In particular, a centrally arranged swelling filament 12 may be loosely placed together with the optical transmission elements 101 and 102 in the cable core surrounded by the cable sheath 11.

A swelling element 10111 may be provided, or a number of swelling elements 10111 may be provided. A swelling element 10111 may be formed as a fiber which comprises a swellable polymer. The fiber may also comprise a matrix polymer in which a swellable filler is embedded. The fiber may also comprise a yarn that is not in fact swellable which has a swellable layer applied to the surface. In this case, the swellable layer may comprise a swellable polymer or a matrix polymer and a swellable filler embedded therein.

A swelling element preferably comprises a polyacrylic acid or a salt of a polyacrylic acid, such as for example sodium polyacrylate, as the swelling material.

The swelling material may in this case be embedded as a filler and a matrix polymer.

In order to produce the optical cable 1 represented in FIG. 1, firstly the optical transmission element 101 is formed. For this purpose, firstly the optical waveguides 10101 and 10102 and the at least one swelling element 10111 are formed. Subsequently, the at least one swelling element 10111 is supplied together with the optical waveguides 10101 and 10102 to an extruder, which extrudes on the buffer tube 1011. After that, the optical transmission element 101 is supplied together with the optical transmission element 102 to a further extruder, which extrudes on the cable sheath 11.

In order to form a swelling element 10111, a fiber may be extruded from the melt of a polymer. Short pieces of fiber may also be created, and spun into a fiber. A polymer which is swellable and highly water-absorbent may be used for the melt. However, a polymer which merely forms a matrix for a swellable filler may also be used, the filler being introduced into a melt of the polymer in a subsequent mixing operation. For example, the swellable filler may be introduced into the matrix of the polymer as a powder.

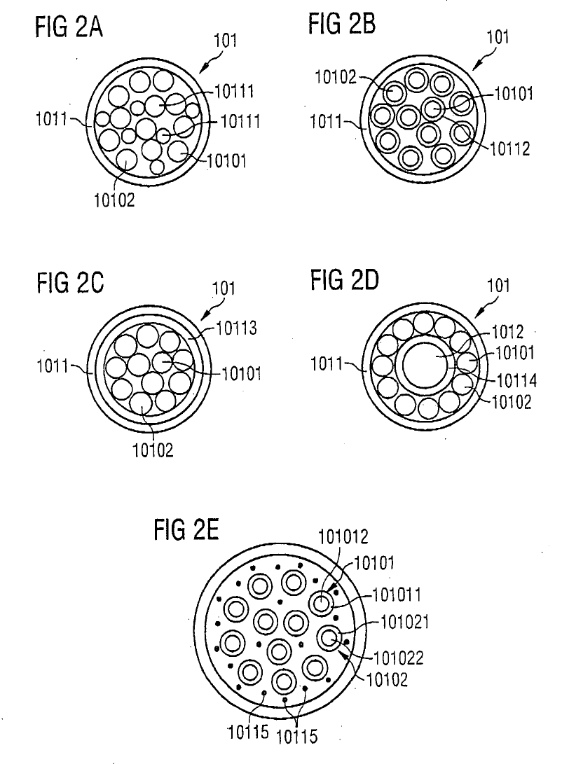

In FIG. 2A, the optical transmission element 101 of the optical cable 1 according to a first exemplary embodiment is represented. The optical transmission element 101 comprises the buffer tube 1011, the optical waveguides 10101 and 10102 and the swelling elements 10111. The optical waveguides 10101 and 10102 and the swelling elements 10111 are surrounded by the buffer tube 1011. The swelling elements 10111 are formed as fibers or yarns. Such a fiber or such a yarn may comprise a swellable polymer or a matrix polymer in which a swellable filler is embedded.

In the case of the exemplary embodiment represented in FIGS. 1 and 2A, the swelling element 10111 may also be created by a swellable layer being formed on a non-swellable fiber or a non-swellable yarn. In this case, the layer may in turn be formed by applying a swellable polymer or by applying a matrix polymer which is filled with a swellable material.

In FIG. 2B, the optical transmission element 101 of the optical cable 1 according to a second exemplary embodiment is represented. The optical transmission element 101 comprises the buffer tube 1011, the optical waveguides 10101 and 10102 and the swelling element 10112. The optical waveguides 10101 and 10102 and the swelling element 10112 are arranged within the buffer tube 1011. Furthermore, the swelling element 10112 is applied to an outer surface of the optical waveguides 10101 and 10102. The swelling element 10112 may comprise a swellable polymer or a matrix polymer into which a swellable filler has been introduced. The swelling element 10112 may be extruded onto the optical waveguides 10101 and 10102. Alternatively, the swelling element 10112 may be formed by coating the outer surface of the optical waveguides 10101 and 10102.

In FIG. 2C, the optical transmission element 101 of the optical cable according to a third exemplary embodiment is represented. The optical transmission element 101 comprises the buffer tube 1011, the optical waveguides 10101 and 10102 and the swelling element 10113. The optical waveguides 10101 and 10102 and the swelling element 10113 are arranged within the buffer tube 1011. Furthermore, the swelling element 10113 is arranged on an inner surface of the buffer tube 1011. The swelling element 10113 may comprise a swellable polymer or a matrix polymer in which a swellable filler is embedded. In this case, the filling element 10113 may be extruded from a melt.

In FIG. 2D, the optical transmission element 101 of the optical cable 1 according to a fourth exemplary embodiment is represented. The optical transmission element 101 comprises the buffer tube 1011, the optical waveguides 10101 and 10102, the yarn 1012 and the swelling element 10114. The optical waveguides 10101 and 10102 and the swelling element 10114 are surrounded by the buffer tube 1011. The yarn 1012 comprises for example polyester and runs within the buffer tube 1011 and alongside the optical waveguides 10101 and 10102. In this case, the yarn 1012 is centrally arranged and fixes for example the position of the optical waveguides 10101 and 10102 within the buffer tube 1011. In a portion of the optical cable 1, the optical waveguides 10101 and 10102 are preferably arranged in the form of a helix around the yarn 1012. The yarn 1012 is therefore also effective as a central element for stabilizing the arrangement of optical waveguides 10101 and 10102. The swelling element 10114 is for example applied as a swellable layer to an outer surface of the yarn 1012. The swelling element 10114 may comprise a swellable polymer or a matrix polymer in which a filler with a swellable material is embedded.

In FIG. 2E, the optical transmission element 101 of the optical cable 1 according to a fifth exemplary embodiment is represented. The optical transmission element 101 comprises the buffer tube 1011 and the optical waveguides 10101 and 10102. The optical waveguides 10101 and 10102 are arranged within the buffer tube 1011. The optical waveguides 10101 and 10102 comprise the fiber coatings 101011 and 101021 and the optical fibers 101012 and 101022, which are surrounded by the fiber coatings 101011 and 101021. The fiber coatings 101011 and 101021 comprise for example an acrylate. The optical transmission element 101 further comprises the swelling element 10115. The swelling element 10115 is formed as a powder which is sprinkled in between the optical waveguides 10101 and 10102 within the buffer tube 1011.

The swelling element 10115, formed as a powder, may also be embedded as a filler in a matrix polymer which is contained in the buffer tube 1011 itself. In this case, the production of the optical transmission element 101 preferably comprises a step of extruding the buffer tube 1011 from a melt which comprises a mixture of the matrix polymer and the filler.

That which is claimed:

1. An optical cable (1), comprising:
a cable sheath (11) and a cable core (101, 102), which is surrounded by the cable sheath (11);
the cable core comprising a centrally arranged swelling filament and at least two optical transmission elements (101, 102);
the at least two optical transmission elements (101, 102) being arranged around the centrally arranged swelling filament (12) and of which at least one (101) comprises:
at least one optical waveguide (10101, 10102);
at least one swelling element (10111, 10112, 10113, 10114, 10115), which comprises a swelling material which can be made to swell by water, in order to seal off the optical transmission element (101);
a buffer tube (1011), which surrounds the at least one optical waveguide (10101, 10102) and the at least one swelling element (10111, 10112, 10113, 10114, 10115).

2. The optical cable (1) of claim 1, wherein at least one (101) of the at least two optical transmission elements (101, 102) has an interspace which is free from gel.

3. The optical cable (1) of claim 1, wherein at least one (101) of the at least two optical transmission elements (101, 102) has within the buffer tube (1011) an interspace (1013) which is adjacent the at least one optical waveguide (10101, 10102) and the at least one swelling element (10111, 10112, 10113, 10114, 10115) and can be sealed in a watertight manner by swelling of the swelling material.

4. The optical cable (1) of claim 1, wherein the at least one swelling element (10111) of at least one (101) of the at least two optical transmission elements (101, 102) is formed as a fiber which is arranged within the buffer tube (1011) and alongside the at least one optical waveguide (10101, 10102).

5. The optical cable (1) of claim 1, wherein the at least one swelling element (10113) of at least one (101) of the at least two optical transmission elements (101, 102) is arranged as a layer on an inner surface of the buffer tube (1011).

6. The optical cable (1) of claim 1, wherein the at least one swelling element (10112) of at least one (101) of the at least two optical transmission elements (101, 102) is arranged on an outer surface of the at least one optical waveguide (10101).

7. The optical cable (1) of claim 1, wherein the at least one swelling element (10111, 10112, 10113, 10114, 10115) of at least one (101) of the at least two optical transmission elements (101, 102) is extruded from a melt of a swellable polymer.

8. The optical cable (1) of claim 1, wherein the at least one swelling element (10111, 10112, 10113, 10114, 10115) of at least one (101) of the at least two optical transmission elements (101, 102) comprises a matrix polymer and a swellable filler embedded therein.

9. The optical cable (1) of claim 1, wherein at least one (101) of the at least two optical transmission elements (101, 102) comprises at least one yarn (1012) with a swelling material which runs within the buffer tube (1011) and alongside the at least one optical waveguide (10101, 10102).

10. The optical cable (1) of claim 9, wherein the at least one swelling element (10114) of at least one of the at least two optical transmission elements (101) is arranged as a layer on an outer surface of the at least one yarn (1012).

11. The optical cable (1) of claim 9 the yarn comprising polyester.

12. The optical cable (1) of claim 1, wherein at least one (101) of the at least two optical transmission elements (101, 102) has an interspace (1013) between the buffer tube (1011) and the optical waveguides (10101, 10102), a powder is arranged in the interspace (1013) and the powder comprises at least one swelling element (10115).

13. The optical cable (1) of claim 12, the powder comprising a further filler.

14. The optical cable (1) of claim 1, wherein the buffer tube (1011) of one of the at least two optical transmission elements (101) comprising a base polymer with a high plasticizer content and a filler and the percentage by mass of the filler within the overall mass of the base polymer and the filler being between 20% and 90%.

15. The optical cable (1) of claim 14, the base polymer having a plasticizer and comprising one of the materials ethyl vinyl acetate and polyvinyl chloride and the filler comprising a swelling powder (10115).

16. The optical cable (1) of claim 1, the at least one optical waveguide (10101) comprising a layer (101011) which is arranged on an outer surface of the optical waveguide (10101) and comprises an acrylate.

17. The optical cable of claim 1, wherein the swelling material of the swelling element (10111, 10112, 10113, 10114, 10115) comprises a polyacrylic acid or a salt of a polyacrylic acid.

18. A method for producing an optical cable (1), comprising the steps of:
creating at least two optical transmission elements (101, 102), of which at least one (101) is created by:
supplying at least one optical waveguide (10101, 10102);
creating at least one swelling element (10111, 10112, 10113, 10114, 10115);
extruding a buffer tube (1011) around the at least one optical waveguide (10101, 10102) and around the at least one swelling element (10111, 10112, 10113, 10114, 10115); and
arranging the at least two optical transmission elements (101, 102) around a centrally arranged swelling element (12).

19. The method of claim 18, the creation of the at least one swelling element (10111, 10112, 10113, 10114, 10115) comprising the steps of:
preparing a melt of a swellable polymer;
extruding the at least one swelling element (10111) as a fiber from the swellable polymer.

20. The method of claim 18, the creation of the at least one swelling element (10111, 10112, 10113, 10114, 10115) comprising:
preparing a melt of a swellable polymer;
extruding the at least one swelling element (10112, 10113) as a swellable sheath around the at least one optical waveguide (10101, 10102).

21. The method of claim 18, the creation of the at least one swelling element (10111, 10112, 10113, 10114, 10115) comprising:
preparing a mixture of a swellable filler and a matrix polymer;
creating a swellable sheath (10112, 10113) for the at least one optical waveguide (10101, 10102) from a melt of the mixture.

22. The method of claim 18, the creation of the at least one swelling element (10114) comprising:
preparing at least one yarn (1012);
coating the at least one yarn (1012) with a swellable material.

23. The method of claim 18, the creation of the at least one swelling element (10115) comprising supplying a powder with a swellable material.

24. The method of claim 18, the creation of the at least one swelling element (10115) comprising supplying a swellable material and supplying an additional filler.

25. The method of claim 18, wherein the swelling element (10111, 10112, 10113, 10114, 10115) comprises a polyacrylic acid or a salt of a polyacrylic acid.
